(19) United States
(12) Patent Application Publication
(10) Pub. No.: US 2021/0315426 A1
(43) Pub. Date: Oct. 14, 2021

(54) FURTHER METHODS AND APPARATUSES FOR DISPENSING AND EXPANDING EXPANDABLE SLIT SHEET MATERIAL

(71) Applicant: David Paul Goodrich, Sedona, AZ (US)

(72) Inventor: David Paul Goodrich, Sedona, AZ (US)

(21) Appl. No.: 17/239,682

(22) Filed: Apr. 25, 2021

Related U.S. Application Data
(63) Continuation-in-part of application No. 16/749,875, filed on Jan. 22, 2020.
(60) Provisional application No. 63/015,610, filed on Apr. 26, 2020.
(60) Provisional application No. 62/795,310, filed on Jan. 22, 2019.

(51) Int. Cl. A47K 10/38

(52) U.S. Cl. CPC A47K 10/38; A47K 2010/3863

(57) ABSTRACT

Various devices and methods for expanding and dispensing expandable slit sheet paper include a support member for a roll of expandable slit sheet paper. In some embodiments, the roll of expandable slit sheet paper has an interior core member and a roll of expandable slit sheet paper wound on said interior core member. The device preferably includes a tension device that is used to provide tension to resist rotation of the roll or the movement of the expandable slit sheet paper during use. The pressure of the tensioning device creates a friction required to enable the unexpanded slit sheet to be unwind and fed while simultaneously expanding.

The present application is 1) a non-provisional of U.S. Provisional Application No. 63/015,610, filed Apr. 26, 2020 and 2) a continuation-in-part of U.S. application Ser. No. 16/749,875, filed Jan. 22, 2020, which is a non-provisional of U.S. Provisional Application No. 62/795,310, the disclosures of which prior applications are all incorporated herein by reference in their entireties.

### BACKGROUND

### Field

The preferred embodiments of the present invention relate to the use of a tensioning device for applying resistance to the dispensing of slit sheet material thereby expanding the slit sheet material.

### Incorporations by Reference

Further information relating to the paper which can be used in the present invention, slit patterns, and the expansion process is found in U.S. Pat. Nos. 5,538,778; 5,667,871; 5,688,578; and 5,782,735; 3,908,071; Ser. No. 14/901,977; WO1984002936A1; US20020060034; US 2007/0240841 A1; U.S. Pat. Nos. 3,104,197; 3,220,116; 3,266,972; 3,269,393; 3,908,071; 6,024,832; 6,458,447 B1; and 6,712,930 B2; the disclosures of which are incorporated by reference herein, as though recited in full.

This application incorporates by reference herein, as though recited in full, the disclosures of publication No. US 2018/0222665, and publication No. US 2018/0127197.

### Description of the Related Art

There have been a number of devices to dispense expanded slit sheetmaterial that are motorized for powered dispensing and manual devices that must provide a tensioning method. For example, Geami WrapPak® ExBox is a self-contained, disposable, and recyclable combination of die cut Kraft paper and tissue interleaf that in combination is used to cushion and protect fragile items during shipment.

### SUMMARY OF THE PREFERRED EMBODIMENTS

The preferred embodiments overcome problems in the above and/or other background art.

Another notable aspect according to some preferred embodiments of the present invention is to create a lightweight expanded slit sheet made from paper using a paper dispenser that provides for the expansion of a slit sheet of paper.

In accordance with one illustrative broad embodiment of the invention, a dispenser is provided for expanding slit paper in which a roll of slit sheet material can be installed without removing any parts during each roll change.

### Embodiment 1

According to some illustrative embodiments, a device for dispensing expandable slit sheet paper is provided that includes: a roll of expandable slit sheet paper, an interior core member, wherein said roll of expandable slit sheet paper is wound on said interior core member, means for variably applying a frictional resistance to the rotation of said core member by varyingly applying pressure on an interior of said core member, such as, in some embodiments, with a rigid pressure member.

In some implementations, the device further includes reciprocating mechanism for reciprocating the rigid pressure member. In some examples, the reciprocating mechanism includes a rotatable cam. In some examples, the rigid pressure member includes a reciprocated shim. In some examples, the shim includes a curved outer surface that is movable towards and away from the inside surface of the core. In some examples, the shim has a radius of curvature similar to that of the core. In some examples, there is less than 3 shims. In some examples, there is one shim such that pressure is applied in a single region by a surface of the one shim.

In various embodiments, one or more of the various features described herein-below in relation to Embodiment 1 or in relation to other Embodiments can be employed within this embodiment.

### Embodiments 2 and 4

According to some other illustrative embodiments, a device for dispensing expandable slit sheet paper is provided that includes: a roll of expandable slit sheet paper, an interior core member, wherein said roll of expandable slit sheet paper is wound on said interior core member, a core-attachment member configured to be fixed to the core for rotation with the core during use, means for variably applying a frictional resistance to the rotation of said core member by varyingly applying pressure directly or indirectly to the core-attachment member.

In some examples, the means for variably applying a frictional resistance to the rotation of said core member by varyingly applying pressure directly or indirectly to the core-attachment member applies pressure directly to the core-attachment member. In some examples, the core-attachment member is configured to be inserted at least partly within the interior of the core. In some examples, the core-attachment member is press-fit within the core. In some examples, the core-attachment member is secured to the core by one or more projectable member that extends outwardly to grip an interior of the core. In some examples, the means for variably applying a frictional resistance to the rotation of said core member by varyingly applying directly or indirectly to the core-attachment member includes variably applying pressure with a rigid pressure member. In some examples, the device further includes a reciprocating mechanism for reciprocating the rigid pressure member. In some examples, the reciprocating mechanism includes a rotatable cam. In some examples, the rigid pressure member includes a reciprocated shim. In some examples, the shim includes a curved outer surface that is movable towards and away from the inside surface of the core. In some examples, the shim has a radius of curvature similar to that of the core. In some examples, there are less than 3 shims. In some examples, there is one shim such that pressure is applied in a single region by a surface of the one shim.

In various embodiments, one or more of the various features described herein-below in relation to Embodiment 2 or 4 or in relation to other Embodiments can be employed within this embodiment.

### Embodiment 3

According to some other illustrative embodiments, a device for dispensing expandable slit sheet paper is provided that includes: a roll of expandable slit sheet paper, an interior core member, wherein said roll of expandable slit sheet paper is wound on said interior core member, means for applying a frictional resistance to the rotation of said core member by applying pressure or resistance to at least one face surface of the expandable slit sheet paper.

In some examples, the device further includes at least one roll that is configured to be moved against a face surface of the expandable slit sheet paper. In some examples, the device further includes a pair of opposing rolls that are configured to apply resistant to the paper after exiting the roll. In some examples, the device further includes at least one roll that is adapted to be moved towards a face of the paper. In some examples, the device further includes at least one roll that is adapted to be moved towards a face of the paper after extending from the paper roll.

In various embodiments, one or more of the various features described herein-below in relation to Embodiment 3 or in relation to other Embodiments can be employed within this embodiment.

According to some other illustrative embodiments, a device for dispensing expandable slit sheet paper is provided that includes: a roll of expandable slit sheet paper, a frame configured to rotatably support the roll of expandable slit sheet paper; a plurality of rollers configured to receive an end of the expandable slit sheet paper; at least one of said plurality of rollers being configured to apply resistance to the expandable slit sheet paper, whereby when the expandable slit sheet paper is manually pulled from a distal end of the expandable slit sheet paper, said expandable slit sheet paper is expanded.

In some examples, the plurality of rollers includes a pair of rollers, said pair of rollers being arranged such that the expandable slit sheet paper is passed in between said pair of rollers. In some examples, at least one of said pair of rollers is movable with respect to said expandable slit sheet paper. In some examples, an upper one of said pair of rollers is movable with respect to said expandable slit sheet paper. In some examples, said expandable slit sheet paper is configured to follow an S-curve between said pair of rollers, with said expandable slit sheet paper extending in an arc around at least a portion of a periphery of at least one of said pair of rollers. In some examples, said expandable slit sheet paper is configured to extend underneath and past a bottom of a lower one of said pair of rollers, around a front side of said lower one of said pair of rollers, backwardly between said pair of rollers, and around and over the top of an upper one of said pair of rollers. In some examples, the distal end of the expandable slit sheet paper is configured to be manually grasped after passing around and over the top of the upper one of said pair of rollers. In some examples, said roll of expandable slit sheet paper is supported on a rod that extends through a center of said roll, and wherein said frame includes at least one lateral side member configured to support said rod. In some examples, said frame includes two lateral side members configured to removably support opposite ends of said rod. In some examples, said two lateral side members include receiving slots configured to removably support said rod. In some examples, said lateral side members are made of metal. In some examples, said lateral side members are made of steel. In some examples, said device is configured to convey at least one additional layer of sheet material. In some examples, said at least one additional layer of sheet material includes an interleaf layer. In some examples, said at least one additional layer of sheet material includes an additional expandable slit sheet paper layer. In some examples, said device further includes a mechanism for adjusting the resistance applied by said at least one of said plurality of rollers to said expandable slit sheet paper. In some examples, said mechanism for adjusting includes manually rotated member that increases or decreases resistance applied to the expandable slit sheet paper based on the rotational position of said manually rotated member. In some examples, said expandable slit sheet paper is made with an extensible paper. In some examples, said extensible paper has an extensibility in a machine direction of greater than 3%. In some examples, said extensible paper has an extensibility of between about 3-20% in a machine direction. In some examples, said extensible paper has an extensibility of between about 3-9% in a machine direction.

In various embodiments, one or more of the various features described herein-below in relation to Embodiment 3 or in relation to other Embodiments can be employed within this embodiment.

### Embodiment 5

According to some illustrative embodiments, a device for dispensing expandable slit sheet paper is provided that includes: a roll of expandable slit sheet paper, an interior core member, wherein said roll of expandable slit sheet paper is wound on said interior core member, means for variably applying a frictional resistance by: a) varyingly applying resistance at at least one face surface of the expandable slit sheet paper; b) variably applying a frictional resistance to the rotation of said core member by varyingly applying pressure on an interior of said core member with a rigid pressure member; c) variably applying a frictional resistance to the rotation of said core member by varyingly applying pressure directly or indirectly to a core-attachment member; and/or d) otherwise variably applying a frictional resistance that resists rotation of the roll and/or movement of said expandable slit sheet paper; and wherein said means for variably applying a frictional resistance includes an automation mechanism for automated control of the frictional resistance.

In some examples, the automation mechanism includes a computer or controller. In some examples, the automation mechanism includes a mechanism for manually setting a desired resistance which is imparted via the automation mechanism. In some examples, the mechanism for manually setting includes a manual dial, a key pad or other input device.

In various embodiments, various features described herein related to Embodiment 5 can be employed within the context of any of the embodiments described herein.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are described by a way of example, and not limitation, in relation to the accompanying figures, in which:

FIGS. 1-4 show a first embodiment, wherein:

FIG. 1 is a perspective view of the bar-type expander system that comprises an L-shaped frame non-rotationally affixed to a sleeve holder;

FIG. 2 is a perspective view of a sleeve as it sits on the sleeve holders as shown in FIG. 1 and a shim member is shown in the up position through an opening in the sleeve;

FIG. 3 is a perspective view of the paper roll/paper core mounted on and affixed to the sleeve; and

FIG. 4 is a side view of the friction system in which a rotatable shaft turns the cam block to raise or lower the shim member.

FIGS. 5-9 show a second embodiment, wherein:

FIG. 5 is a perspective view of an interior core insert member;

FIG. 6 is a perspective view of the core insert member resting on a puck that supports the core insert member on the dispenser;

FIG. 7 is a perspective view of the core insert member resting on a puck with a tension bar positioned to apply pressure to the core insert member;

FIG. 8 is a perspective view of the core insert member fully inserted into the paper core with the tension bar in contact with the core insert member; and

FIG. 9 is a perspective view of the paper roll as part of the assembly.

FIG. 10 shows a third embodiment, in which FIG. 10 is a perspective view of a nip roller dispensing system where a roll of slit sheet paper sits on a rod in a frame, is fed through a pair of rubberized rotational resistance rollers 1006, and exits expanded.

FIGS. 11-12 show a fourth embodiment of the invention similar to that of the first embodiment of FIGS. 1-4, along with an intermediate sleeve.

FIGS. 13-14 show other embodiments of the invention in which an automated tensioning mechanism is provided.

FIGS. 15-16 show other embodiments in which resistance rollers are employed according to some embodiments.

FIGS. 17-20 are schematic diagrams depicting expandable slit sheet material layers in some illustrative embodiments.

FIGS. 21-25 show other embodiments employing an S curve manner of dispensing.

FIGS. 26 and 27 show illustrative expandable slit sheet material employed in some embodiments of the invention.

### DETAILED DESCRIPTION OF THE PREFERRED EMBODIMENTS

While the present invention may be embodied in many different forms, the illustrative embodiments are described herein with the understanding that the present disclosure is to be considered as providing examples of the principles of the invention and that such examples are not intended to limit the invention to preferred embodiments described herein and/or illustrated herein.

Illustrative Expandable Slit Sheet Paper:

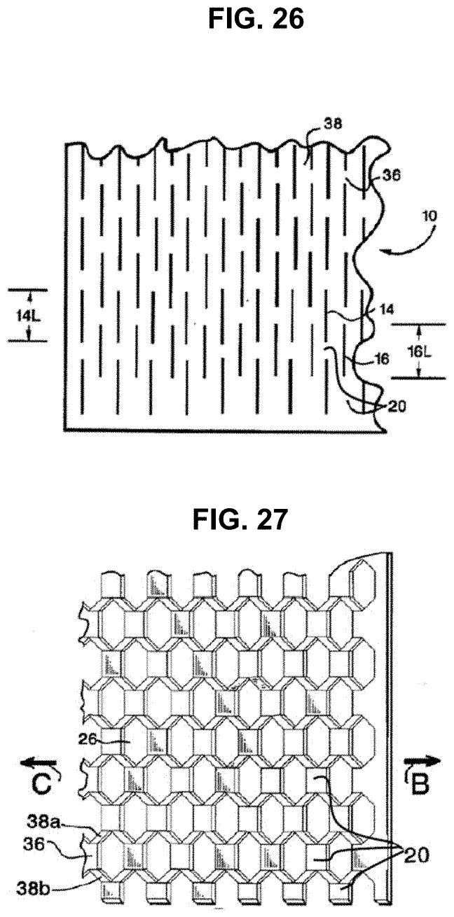

FIG. 26 is a plan view of an illustrative expandable slit sheet paper in an unexpanded state, and FIG. 27 is a plan view of the illustrative expandable slit sheet paper in an expanded state, which illustrative paper can be employed for expansion in illustrative embodiments of the present invention.

FIGS. 26 and 27 depict an illustrative expandable slit sheet paper that can be expanded with systems and methods of the present invention in some illustrative embodiments of the invention. Towards that end, FIG. 26 is an illustration of an exemplary slit pattern in an illustrative expanded slit sheet. The expandable slit sheet paper shown in FIG. 26 operates as an expandable cell-forming paper that can be expanded to an expanded state as shown in FIG. 27. FIG. 26 shows an illustrative section of an expandable slit sheet 10 in an unexpanded (unopened) state, with staggered rows of slits 14 and 16 that extend entirely through the width of the sheet 10, and land portions 20 extending between adjacent slits within rows 14 and 16. As shown in FIG. 26, in some preferred embodiments, the slit lengths 14L and 16L are uniform across the face of the sheet 10; similarly, the distance and area of each row spacing 38 (i.e., between adjacent rows) and each slit spacing 36 (i.e., between adjacent slits) are also uniform. Although an expandable slit sheet can be formed with a variety of slit patterns, the illustrative example shown in FIGS. 26 and 27 depict an illustrative example to scale with illustrative lengths of slits, spacing between slits, proportional relationships of sizes of created hexagonal cells, land portions and leg portions, etc., according to some illustrative examples with such as drawings being to scale in some illustrative and non-limiting embodiments. In FIG. 27, the sheet 10 shown in FIG. 26 has been subjected to an expansion force in the direction of arrows B and C and opened to an open cell formation. In that regard, in this illustrated example, the open cell formation results in hexagonal shaped cells as shown in FIG. 27. In particular, as depicted, the slits 14 and 16 are in an opened state in which the sheet 10 is oriented to have an array of three-dimensional hexagonal cells 26, with substantially rectangular land portions 20 within the slit spacings 36 situated at an inclined angle (i.e., such as to be transverse to the original plane of the sheet 10), and the leg portions 38a and 38b connecting the land portions between the row spacings having been warped to, e.g., slightly less than a 90° angle to the original plane of the sheet. The leg portions 38a and 38b are basically mirror images of one another and connect the land portions 20 such as to form the three-dimensional hexagonal cells.

In the preferred embodiments, systems and methods of the preferred embodiments of the present invention can be employed for expanding an expandable slit sheet similar to that shown in FIGS. 26 and 27.

Extensible Paper Employed in Some Preferred Embodiments:

In some more preferred embodiments, the expandable slit sheet paper is made with an extensible paper. In some most preferred embodiments, extensible papers as set forth in the present inventor's U.S. Pat. No. 10,669,086 are employed, the entire disclosure of which is incorporated herein by reference.

According to some embodiments, the extensible paper is extensible in a machine direction in a range of at least 5%. According to some embodiments, the extensible paper is extensible in a cross direction in a range of at least 5%. According to some embodiments, the extensible paper is extensible in a machine direction in a range of at least 5% and in a cross direction in a range of at least 5%. According to some embodiments, the extensible paper is extensible in a machine direction in a range of at least 6% and in a cross direction in a range of at least 6%. According to some embodiments, the extensible paper is extensible in a machine direction in a range of at least 7% and in a cross direction in a range of at least 7%. According to some, most preferred, embodiments, the extensible paper is extensible in a machine direction in a range of at least 8% and in a cross direction in a range of at least 8%. According to some embodiments, the extensible paper is extensible in a machine direction in a range of between 5% to 15% and in a cross direction in a range of between 5% to 15%. According to some embodiments, the extensible paper is extensible in a machine direction in a range of between 7% to 15% and in a cross direction in a range of between 7% to 15%.

According to some illustrative embodiments, the plurality of slits each have a width of between 0.35 and 0.65 inches; according to some embodiments, the plurality of slits each have a width of between 0.45 and 0.55 inches. According to some embodiments, the plurality of slits each have a width of about 0.5 inches. According to some embodiments, the plurality of slits each have a width of less than 0.5 inches. According to some embodiments, the plurality of slits each have a width of less than 0.45 inches. According to some embodiments, the plurality of slits each have a width of less than 0.4 inches.

In some more preferred embodiments, extensible papers as set forth in the above-referenced U.S. Pat. No. 10,669,086 are employed. Towards that end, the following paragraphs (in quotations) under this section are quoted from the '086 patent set forth details of extensible papers according to some preferred embodiments that can be employed in preferred embodiments of the present invention.

“For the purposes of the present invention, the term ‘extensible’ as applied to paper sheets, means a paper sheet that is able to stretch in a longitudinal direction of the paper sheet upon applying a force in the longitudinal direction of the paper sheet. Illustrative extensible sheets are disclosed in U.S. Pat. No. 3,908,071, U.S. patent application Ser. No. 14/901,977 (U.S. Pat. No. 9,945,077), International Application No. WO 1984002936, U.S. Publication Nos. 2002/0060034, 2007/0240841 (U.S. Pat. No. 7,918,966), and U.S. Pat. Nos. 3,104,197, 3,220,116, 3,266,972, 3,269,393, 3,908,071, 6,024,832, 6,458,447, and 6,712,930, the entire disclosures of which are incorporated by reference herein, as though recited in full. It should be understood that the stretching of an extensible paper must be measured in an unslit sheet of paper. As disclosed in U.S. Pat. No. 3,266,972, the test and characterization procedures employed in measuring elongation (extensibility) properties can be in accordance with standard TAPPI test Elongation T457. In addition, as disclosed in U.S. Pat. No. 3,266,972, the expression ‘extensible papers’ means a paper having an increasable elongation in the machine direction as compared to standard, non-extensible Kraft paper.”

“In some preferred embodiments, extensible paper can be produced by varying the accumulation of paper fibers by essentially slowing the paper feeding process during the drying method to trap extra fibers that make the paper appear to have microscopically sized rows of paper that you would see if one were to pleat the paper. The difference is that extensible paper's microscopic rows are adhered to each other through the use of binders and other types of adhesives in conjunction with the drying process. Reference is made to patent U.S. Application No. 2007/0240841 (U.S. Pat. No. 7,918,966) where the purpose is to create a non-creped extensible paper that does not easily disconnect from itself. In addition, the surface of the extensible paper is still fairly flat.”

“In the preferred embodiments of the present invention, the extensible paper that is employed has low extensible properties as compared to other types of extensible papers. In this regard, an optimal extensible paper enables a smooth transition from an unexpanded to the expanded slit sheet by providing a small amount of stretching at the very start of expansion of the extensible slit sheet paper material.”

“In some exemplary constructions, during expansion of a slit sheet, the force required to initiate expansion is substantially higher than the force required to continue expansion. For example, once the paper initially starts to bend at the slits, the expansion continues more easily during continued bending at the slits. The force required to continue the expansion of the slit sheet during this continued bending is dramatically reduced beyond the above-noted initial expansion. In some preferred embodiments, the extensible slit sheet paper substantially reduces the force required to initiate expansion. On the other hand, in some preferred embodiments, during the above-noted continued expansion, the extensible paper does not substantially stretch simultaneously with the process of expanding the slit sheet paper; otherwise, the expanded sheet might not optimally be made into a cushioning wrap.”

“It should be noted that in this application, all theories related to functioning of the invention are provided to facilitate appreciation of concepts of the invention, rather than by way of limitation. Extensible paper, as designed, stretches as part of an increase in paper strength. In some embodiments, the functioning of the invention involves that the extensible slit sheet paper substantially utilizes the extensible property to ease the rotating the cells into the stretched shape and to resist tearing of the slit sheet during the expansion step. This means that at the initial point at which the cell rotates (i.e., initiating rotation between legs 38a and 38b on each side of the slit and land 20) the extensible slit sheet paper is substantially enhanced by the extensible paper's ability to stretch. In some embodiments, the functioning of the invention, thus, involves that extensible papers' properties are substantially utilized at this initial point and substantially finished as soon as the cell begins to rotate into its three-dimensional shape (i.e., after this initial point, the reliance on the extensible nature of the paper may be less substantial or even non-existent). After that initial point, the slit pattern properties, regardless of paper type, opens with greater ease to the point at which it forms a hexagon. Accordingly, in some embodiments, the extensible property substantially merely comes into play at the initial moment of expansion. In some other embodiments, while the extensible features of the paper comes into play most substantially at this initial point of rotation, the extensible features of the paper can have some affect during further expansion of the paper, whereby the initial point of expansion can be substantially facilitated due to extensibility and further expansion can also be, at least, somewhat facilitated due to extensibility.”

“In some of the preferred embodiments, preferable extensible papers that can be employed include extensible papers where the purpose of the extensible nature is to provide the type of stretching found for the use of multi-wall bags for heavy weight items like cement, or seed and the like. U.S. Patent Publication No. 2016/0355985 (U.S. application Ser. No. 14/901,997) and U.S. Pat. Nos. 3,104,197 and 3,266,972 teach the manufacture and properties of this form of extensible paper. Further teachings can be found in “Understanding sheet extensibility”, R. S. Seth, Pulp & Paper Canada T31, 106:2 (2005) III, pages 33-40 (T31-T38). The disclosures of the foregoing patents, patent publication, and printed publication are incorporated herein by reference, as though recited in full.”

“The prior expanded slit sheet art (See, e.g., U.S. Pat. Nos. 5,538,778, 5,667,871, 5,688,578, and 5,782,735) focused on paper strength to inhibit tearing during the expansion process and Kraft paper was satisfactory because the strength required coincided with the thickness required to make a satisfactory wrapping product. The increased strength of an expandable sheet does not contribute to or increase the value/performance of the expansion of the slit sheet material. It has now been found by the present inventor that an expandable slit sheet paper can be substantially improved by the use of an extensible sheet. In the preferred embodiments, this use of an extensible slit sheet paper advantageously provides a reduction in force required to open the slit sheet and therefore provides a faster and easier expanding process for the user of the expanded slit sheet. The unexpected benefit resulting from the reduction in force at the very start of the expansion of the slit sheet provides an unexpected improvement to the slit sheet packaging product and renders the employment of the extensible paper highly unique. Notably, the prior expanded slit sheet paper persisted in and was widely used in the marketplace for decades without the contemplation of the present invention or the potential advantages therefrom.”

“As set forth in this application, the present inventor has discovered that the force needed to expand an expandable slit sheet paper is far greater than the force required to expand an extensible slit sheet paper. By way of example, a 50 pound Kraft paper expandable slit sheet that is 15″ wide prior to expansion requires approximately 4-6 pounds or 0.4 pounds per inch, whereas the force required to expand an extensible slit sheet of the same paper weight is 0.15-0.22 pounds per inch. This is a marked difference between the papers. Kraft paper has the strength to provide an acceptable expandable slit sheet. However, unexpectedly, the extensible slit sheet imparts an ease of expansion that greatly reduces the force required to expand the slit sheet, not based on the main purpose for extensible paper which is to increase its tensile strength but, rather, its capability to stretch. Since extensible paper is higher in cost and Kraft paper was strong enough, it was not previously known that extensible paper could be of benefit for making slit paper sheets of the types found in, e.g., U.S. Pat. Nos. 5,538,778, 5,667,871, 5,688,578, and 5,782,735, and U.S. Non-Provisional application Ser. No. 15/428,144. For example, it was not appreciated that an extensible slit sheet could have provided an equivalent strength to light weight, thin papers that previously had no applicability as a wrapping product. Light weight Kraft paper tears more easily than heavier weights of Kraft paper. It has now been found that the extensible paper enables the use of the lighter weight expanded slit-sheet papers that also advantageously provide gentler cushioning required by fragile items when a slit sheet is expanded, in contrast to the more rigid cushioning provided by heavier weight expanded slit-sheet papers.” “Reference is particularly made to the graph of Table 1 on page 5 of U.S. Patent Publication No. 2016/0355985 (now U.S. Pat. No. 9,945,077) as if recited in full, that describes paper strength based on certain manufacturing techniques. Within the graph is a column describing elongation at the point of paper break (or tearing of fibers) separated into two sub columns of the machine direction (MD) and cross direction (CD), also referred to as transverse direction. The elongation percentage of Table 1 ranges from 5.3% to 7.1% in the cross direction (CD) and 3.3% to 10.6% in the machine direction (MD).”

“Reference is also made to U.S. Pat. No. 3,266,972 within Table III of column 5 which references elongation in the percentage range from 3.7% to 4.6% in the CD or cross direction and 9.7% to 11.1% in the machine direction.”

“In both '985 and '972, the variations are based on the manufacturing process that places an emphasis on tensile strength and stretch in either the cross direction or machine direction accordingly.”

“The present inventor has discovered that for the purposes of expanding an extensible slit sheet paper for use as a packaging wrap and/or void fill, machine direction extensible ranges from 1%-9% provide an adequate extensibility, with 1% to 6% preferred, and 1% to 4% most highly preferred. The lower the extensibility coincides with lower costs of the paper per square foot. As indicated above, it should be understood that extensibility is measured on unslit paper.”

“In some alternative embodiments, machine direction extensibility ranges of the extendible slit sheet paper can have ranges of:
a) from 1.5%-9%, or more preferably from 1.5% to 6% preferred, or even more preferably from 1.5% to 4%; or
b) from 2%-9%, or more preferably from 2% to 6% preferred, or even more preferably from 2% to 4%; or
c) from 3%-9%, or more preferably from 3% to 6% preferred, or even more preferably from 3% to 4%.”

“For the purposes of expanding the slit sheet paper for use as a packaging wrap and/or void fill, it has been found that cross direction extensible ranges from 1%-5% provides an adequate extensibility with 1% to 4% preferred, and 1% to 3% most highly preferred.”

“In some alternative embodiments, cross direction extensibility ranges of the extendible slit sheet paper can have ranges of: a) from 1.5%-5%, or more preferably from 1.5% to 4%, or even more preferably from 1.5% to 3%; or b) from 2%-5%, or more preferably from 2% to 4%, or even more preferably from 2% to 3%.”

“In combination with the extensible paper, a smaller, lighter weight, and recyclable version of an expander can be employed (such as, e.g., made entirely or substantially entirely with recyclable cardboard in some illustrative embodiments). This expands the market to customers that use a very small amount of wrap as compared to the industrial market. It also provides for a less expensive expansion device to be employed for expanding the slit paper. Additionally, it enhances the ease of use by the packer by providing for less ripping during the wrapping process that occurs when the tension is not properly set. This occurs as the roll, during its continued use, becomes smaller and lighter in weight. As the roll of expanded slit sheet becomes lighter the tension required increases. Thus, there need for a varying tensioning method. With the use of the extensible paper, the tension required is significantly decreased and the strength of the paper is increased. Both benefit the person wrapping by making the tensioning required much less precise to the point at which, a single tension setting can be used with little or no adjustment. If the tension is set higher than necessary, the increase in strength from the extensible paper keeps the product from tearing and therefore makes it easier for the packer to use. Therefore, the packer can make fewer adjustments as the slit sheet roll becomes smaller and smaller.”

“The reduction in the force required to expand the slit paper enables a new product to be created using lighter weight papers. In the past, expanded slit sheet paper is primarily used as a wrapping product whereas its use as a void fill would be in limited circumstances due to void fill being typically the cheapest, that is, the lowest cost of all packaging products. The increased strength of the extensible sheet enables the use of a thinner and lighter weight slit sheet paper as a void fill product. If the expanded slit sheet is not being used as a wrap, then the thicker 0.005″, 50 pounds per 3,000 square feet paper and above is not required and a lighter weight 0.003-0.0045″ thick, 30-40 pounds per 3,000 square feet paper can be used as void fill. It can also be used to provide cushioning that other paper void fill products have not been able to provide. It has now been found that even though the extensible paper has a 10% higher price, the use of a thinner paper provides much more square footage per ton and more than compensates for the increased cost of the extensible paper as compared to Kraft paper.”

### First Embodiment

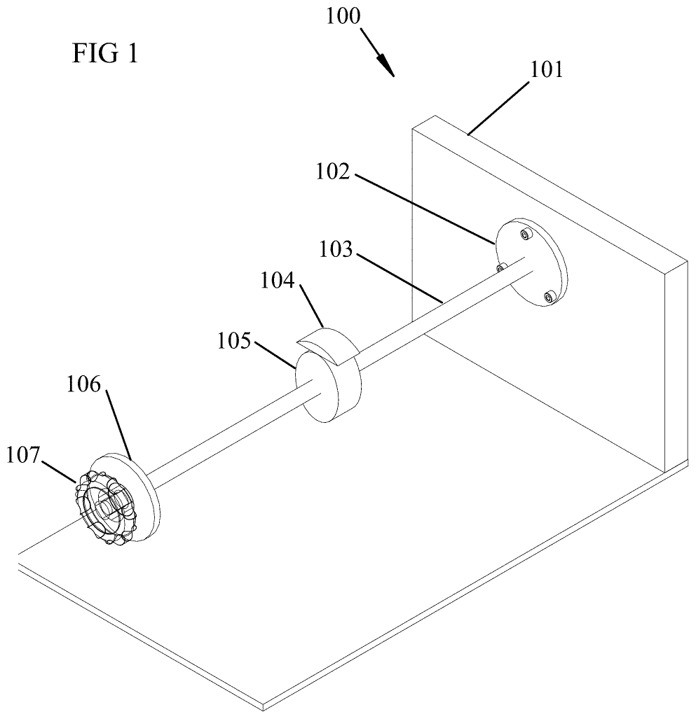

FIGS. 1 to 4 show a first embodiment of the present invention.

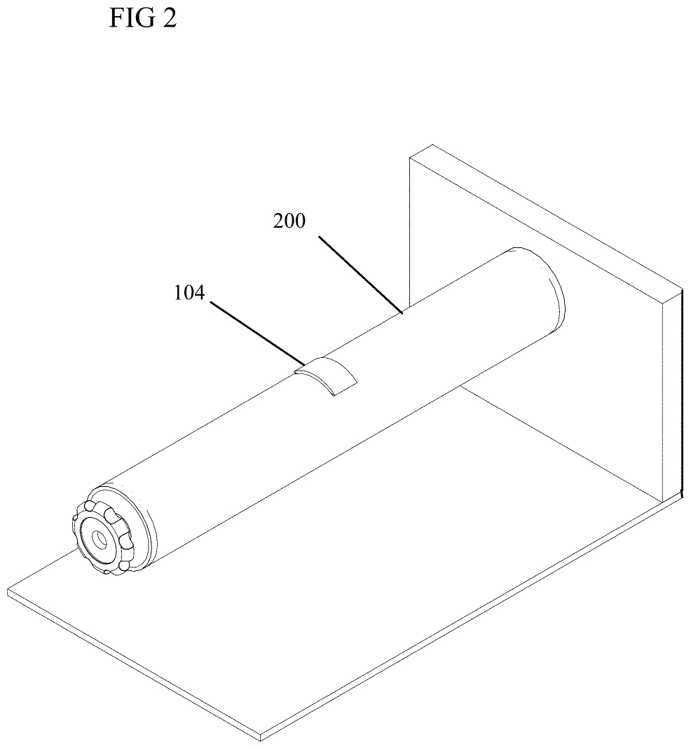

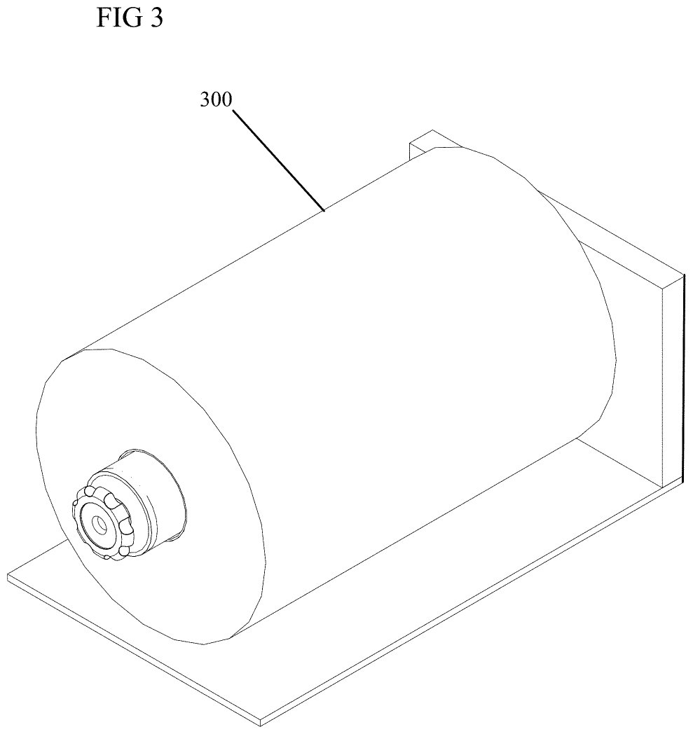

FIG. 1 is a perspective view of the bar-type expander system 100 that includes an L-shaped frame 101 non-rotationally affixes to a first sleeve holder plate 102. The first sleeve holder plate 102 together with the second sleeve holder plate106, respectively, affix a substantially cylindrical sleeve 200 (omitted in FIG. 1 to show internal parts, but shown in FIG. 2). The first sleeve holder plate 102 is fixed to the frame 101 (such as via bolts or the like as shown), and a shaft 103 is rotatably supported such as to extend from the plate 102 (such as, e.g., being rotatably received within a central opening within the plate 102). Along a central region of the shaft 103 is a CAM block 105 that is fixedly attached to the shaft in a manner to rotate with the rotation of the shaft 103 around a central axis of the shaft. Preferably, the CAM block is shaped with a non-circular outer peripheral shape whereby rotational movement of the CAM block around an axis of the shaft 103 will result in movement (e.g., raising and lowering) of the friction shim 104 that is, thus, caused to press against the internal paper core of within a roll 300 as shown in FIG. 3. Although not shown in FIG. 1, the shim 104 is preferably mounted such as to fit within and be projectable from an opening or hole at an upper side of the sleeve 200 as shown in FIG. 2.

In a preferred embodiment, as shown in FIG. 1, a manually rotatable knob or turning handle 107 is mounted to the end of the shaft 103, such as to be capable of rotating the shaft 103 around its central axis of the shaft. Preferably, the second sleeve holder 106 includes a central hole through which the shaft 103 extends to the turning handle 107. As a result, a user can manually rotate the turning handle 107, causing the shaft 103 to rotate, which, thus, causes the CAM block 105 to rotate such as to cause the shim 104 to be raised and/or lowered.

In the preferred embodiments, the shim is a projection that is movably received within an opening in the sleeve and which contacts the rotating CAM block 105, and the shim 104 is configured to make sliding contact with a cam surface of the CAM block 105 while the CAM block 105 is rotated such as to impart a variable motion to the shim (e.g., being reciprocatable upwardly and downwardly). The shim is, thus, variably pressed against the interior of the core member and, thus, variably provides a rotational resistance to the drawing of paper from the roll of expandable slit sheet paper. The rotational resistance causes the slit paper to expand as it is drawn from the roll of slit sheet paper.

Thus, in the preferred embodiments, the shim 104 is a member that slides on the CAM block 105 during operation. The shim 104 can be made of a variety of materials. In some preferred embodiments, the shim is relatively rigid and has a smooth outer surface. In some examples, the shim can be a piece of wood, metal, ceramic, or plastic. In some illustrative and non-limiting embodiments, the shim has a thick middle region and tapers to a thin edge as shown. In some embodiments, the shim 104 has a curved contact surface that is configured to follow a curvature of the interior of the core. In some preferred embodiments, the shim 104 is driven between the CAM block 105 and the interior of the core upon which the paper roll is wound. In some implementations, the shim variably separates or spaces the sleeve 200 from the interior core member (not shown) when raised such as to press against the interior of the core while the surface of the shim 104 extends further above a perimeter surface of the sleeve.

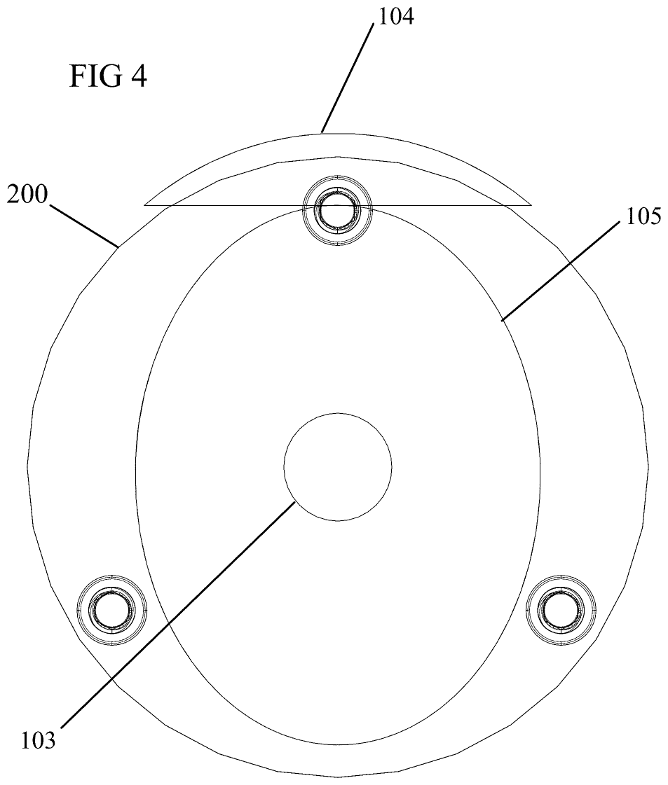

In some preferred implementations, the shim 104 operates as a wedge which fits into the space between the cam block and the interior of the core member, and is pressed by the cam block against the interior of the core member. In some preferred embodiments, the shim 104 has a curved or an arcuate upper surface and a flat or planar surface, thus, providing a bow like configuration as illustrated in FIG. 4. The curved surface preferably coincides with the curvature of the interior core member. On the other hand, the flat or planar lower surface preferably acts as a cam surface that slidingly engages with a corresponding cam surface of the cam block 105.

FIG. 2 is a perspective view of the sleeve 200 as it sits on the sleeve holders 102 and 106 (i.e., with the holder 102 shown in FIG. 1 being hidden in the view of FIG. 2). As shown in FIG. 2, the shim 104 is extendable upwardly through the hole in the sleeve 200 such as to be movably to the interior of the core that is received over the sleeve. In FIG. 2 the shim is depicted in a position raised upward above the outer perimeter of the sleeve upward through the hole in sleeve 200.

FIG. 3 is a perspective view of the paper roll/paper core 300 placed over the sleeve 200 with the sleeve extending through a paper core member at the center of the roll 300.

FIG. 4 is a side view of the friction system shown in FIG. 1 according to some illustrative embodiments. As described above, upon turning the turning handle 107, the shaft 103 is rotated which results in raising or lowering of the shim 104 due to the non-circular outer shape of the cam block 105 (e.g., elliptical outer shape of the cam block in the illustrative example shown in FIG. 4). Thus, turning handle 107 (not shown in FIG. 4) turns the shaft 103, which turns the cam block 105, which raises or lowers the shim 104 in relation to the perimeter surface of the sleeve 200. As shown in FIG. 4, the shim 104 is in a most-raised position due to the radius of the cam block 105 being a maximum at the contact point with the shim 104. In FIG. 4, the three circular elements shown approximately equidistantly around the perimeter of the sleeve 200 show bolts or other fixing elements that fix the sleeve 200 relative to the frame in some illustrative and non-limiting examples.

### Second Embodiment

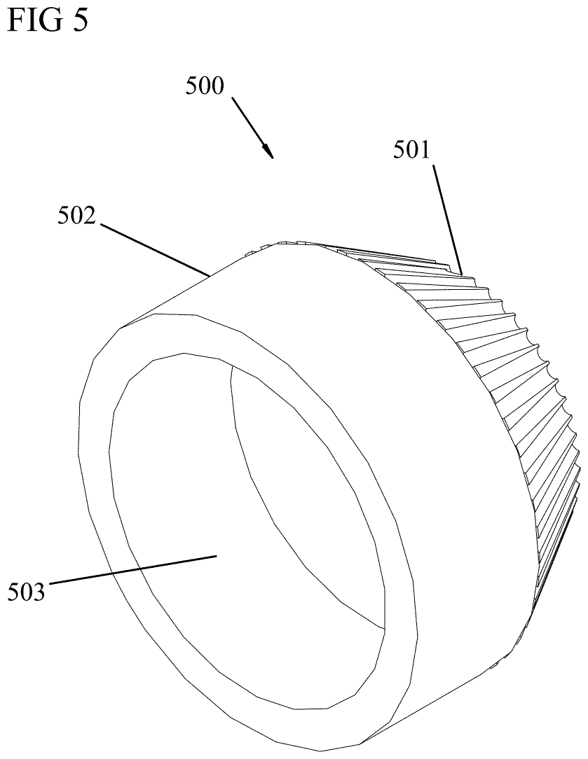

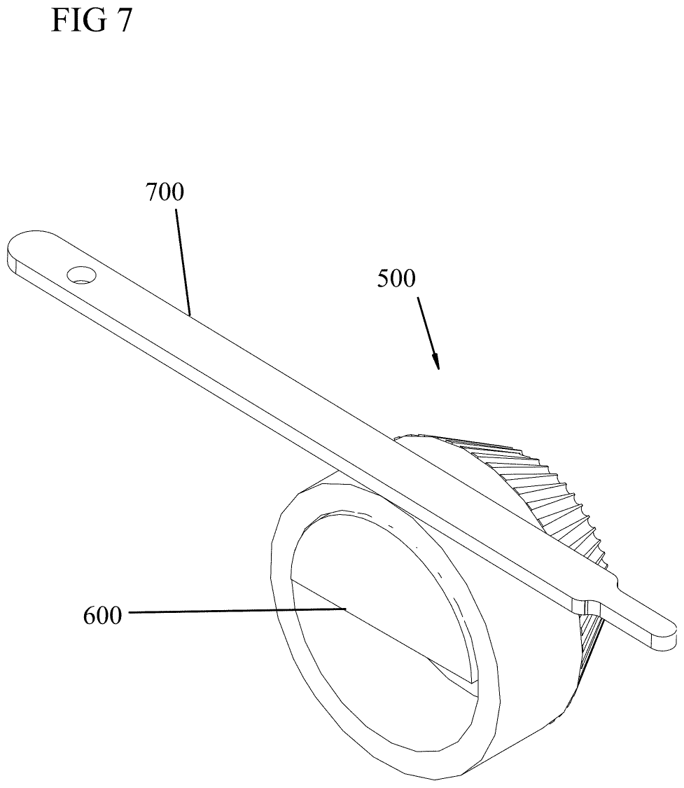

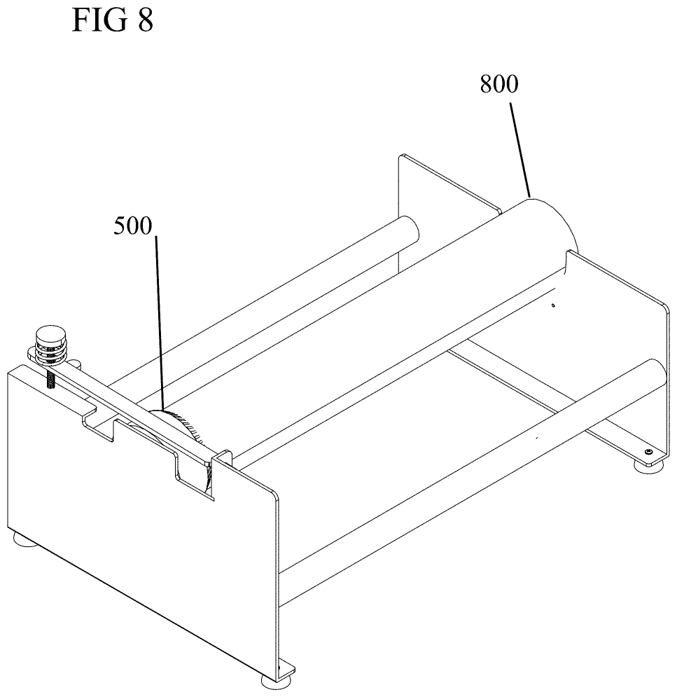

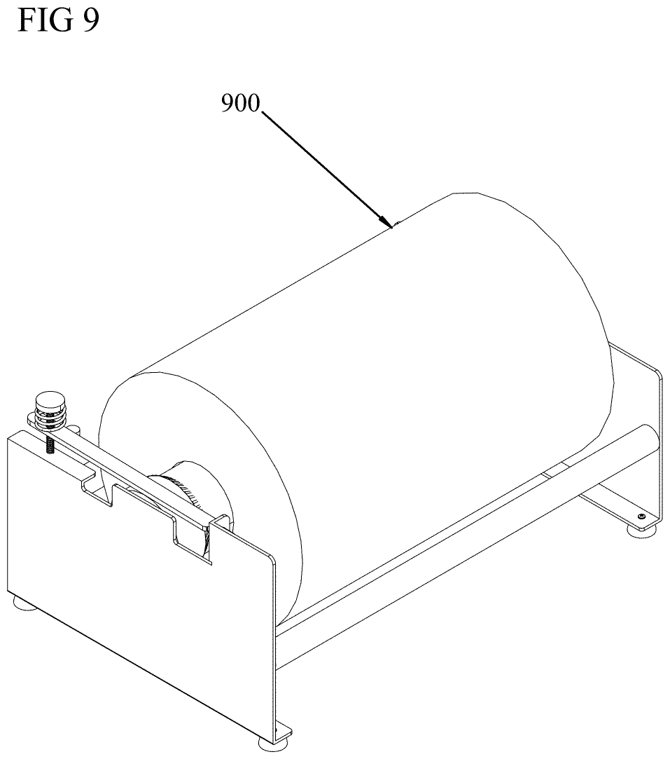

FIGS. 5 to 9 show another embodiment of the present invention. In this second embodiment, a tensioning device is formed as best shown in FIG. 9. In the preferred implementations, as shown in the perspective view of FIG. 5, a paper core insert 500 is provided includes a radial cone 501 is configured to be pushed axially into paper core 800 (see FIG. 8).

In the illustrated embodiment, the insert 500 includes a smooth radial section 502 with open area 503 (e.g., the area 503 can be a cup-shaped circular receiving opening). In addition, the insert 500 as includes a tapered or conical portion adjacent the smooth section 502, which has a radial diameter that decreases in a direction away from the open area 503. As shown the outer surface of the tapered or conical portion preferably include a roughed frictional surface, such as, e.g., a plurality of ridges and/or grooves extending in an axial direction (e.g., generally parallel to an axis of the core). As discussed below, the roughed frictional surface helps to create a firm engagement with the paper core when inserted into an open end of the paper core.

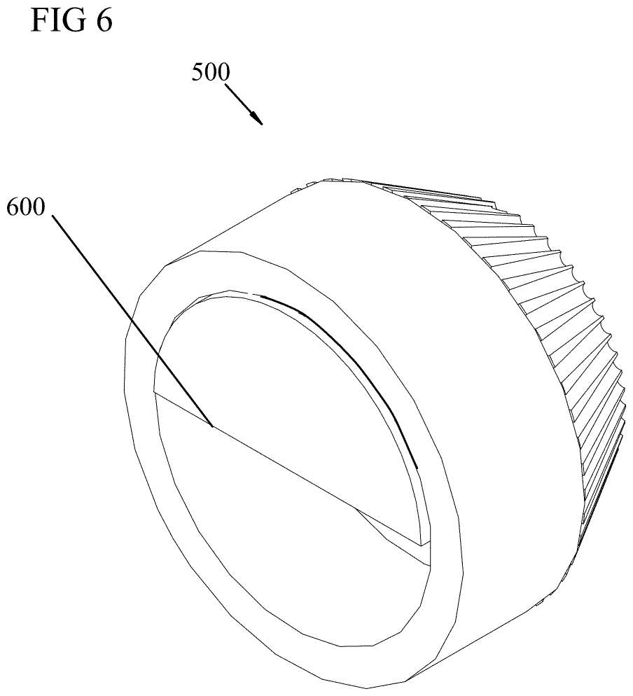

As shown in FIG. 6, the open area 503 of the insert 500 is preferably configured to receive a puck 600. As shown in FIG. 6, the paper core insert 500 preferably rests on the puck 600, such as to support the paper core insert on the dispenser.

FIG. 7 is a perspective view of the paper core insert 500 resting on the puck 600, along with a tensioning bar 700 that is arranged to apply pressure to the smooth portion 502 of the paper core insert 500 and, thus, press the core insert member 500 against the puck member 600. The puck 600 is preferably mounted to a frame of the dispenser, and operates to support the paper core insert 500, which, in turn, supports an end of the core. With reference to WO2019212980A2, FIG. 1 of this latter reference illustrates a core support 102 that functions in a manner that generally corresponds to the functioning of puck 600 by supporting an end of the paper core. The disclosure of WO2019212980A2 is incorporated by reference as though recited in full. In particular, WO2019212980A2 discloses at ¶¶[0036] and [0037] that: “FIG. 1 is a perspective view of the entire tensioning assembly and dispensing structure 100 without the roll of expandable slit paper. The tensioning assembly is mounted on side fixture 101. The tensioning assembly includes a tension member 103, thumbscrew 104, and spring 105. The tension member 103 can be in the form of a rod or bar. The tensioning assembly applies tension, that is, rotational resistance, to the paper core, 204 (shown in FIG. 5) by pressing the core end region 203 (as shown in FIGS. 3 and 4) against core support 102 that is in the form of a support bar that is fixed, that is, attached to fixture 101. The side fixture 106 provides support for the interior core end region [0037] Tensioning assemblies 103, 104 and 105 of FIG. 1 are of the same basic design as disclosed in U.S. nonprovisional patent application Ser. No. 15/428,144 (Publication No. 2018-0222665). On the opposite side from side fixture 101, the bottom of the yoke area 107 supports the paper core end region 201, as shown in FIG. 2. Thus, the paper core end region 201 rests in the yoke area 107 of the side fixture 106. After the paper is loaded, the paper core end region 201 can be held in place by a core positioning member 108 that holds back the paper roll 201 of FIG. 2, thus inhibiting the end core region 201 from sliding on the core support member 102.”

In the perspective view of FIG. 8, in an operation state, the paper core insert 500 is fully inserted into an end of the paper core 800. In that condition, the paper core 800 frictionally engages with the outer surface of the tapered or conical portion (i.e., frictionally engaging the roughed frictional surface (e.g., the plurality of ridges and/or grooves extending in an axial direction). The tensioning device in its preferred embodiment is to be made from aluminum. However, in other embodiments, the tensioning device can be made with wood, steel and/or other metal components. In the preferred embodiments, the tensioning device, including the tension rod, spring and thumbscrew, are of a similar design as found in publication, US 2018/0222665, the disclosure of which is incorporated by reference herein, as though recited in full. In this new embodiment shown in FIGS. 5-9, a new design is provided in which the paper ore insert 500 serves as a short bar on the tensioning side that supports the core 800, while a yoke supports the core on an opposite side as shown.

Among other things, in some embodiments, this combination enables the roll of paper to be loaded without the need for removing the tensioning rod, thumbscrew, and spring. In particular, 2018/0222665 discloses at ¶[0133] that: “FIG. 6 is the single expansion apparatus made up of two yokes 602 and preferably at least three cross members 601. Paper core 608 sits in the yoke 602 and holds the paper roll 603 that is wound around it. A threaded insert 607 receives thumb screw 604 first through the spring 605 and then through roll holder 606 and into the metal threaded insert 607 to enable the roll holder to apply downward pressure to the paper core 608.”

Additionally, the system shown in FIGS. 5-9 provide an advantage in that the friction of the tensioning device can be applied between the tensioning arm and the smooth surface 502 of the insert 500. In that manner, the materials of the tensioning bar and insert 500 can be specially selected for, e.g., frictional qualities and can be made of a refined and consistent shape. In contrast, when tensioning involves application of pressure against a paper core and/or a paper roll on the paper core, the irregular nature of the paper core or paper roll can lead to less controlled tensioning. Moreover, as the smooth surface 502 and the tensioning bar are part of the overall device, the tensioning is consistent and does not depend on characteristics of the paper core or paper roll.

As shown in the perspective view in FIG. 9, when assembled, the paper roll 900 surrounds the paper core 800, which is pressedly engaged to the insert 500. As a result, the insert 500 and the paper core 800 and paper roll 900, thus, rotate in unison around the axis of the paper core 800.

### Third Embodiment

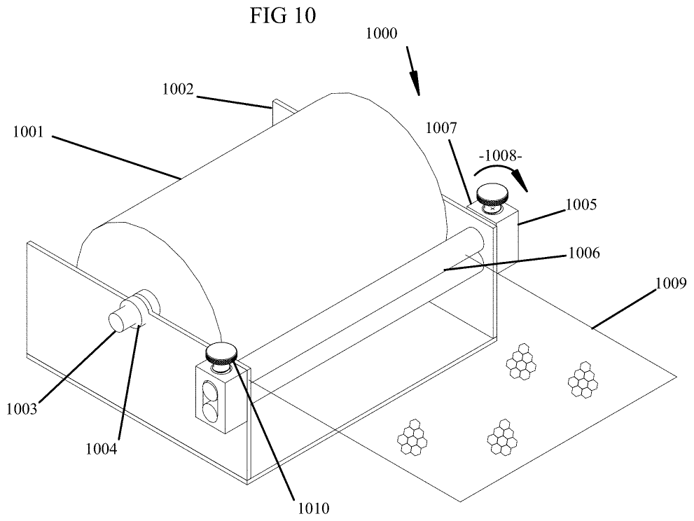

FIG. 10 is a perspective view of the nip roller dispensing system 1000 where slit sheet roll 1000 sits on a rod 1003 in frame 1002 and is kept centered with locking spacers 1004. The expanded slit sheet 1009 is fed through the pair of rubberized rollers 1006 and exits expanded. The spring loaded thumb screws 1010 control of the expansion of the slit sheet material by pressing on rubberized rollers 1006 and can be adjusted to increase tension as shown with arrow 1008.

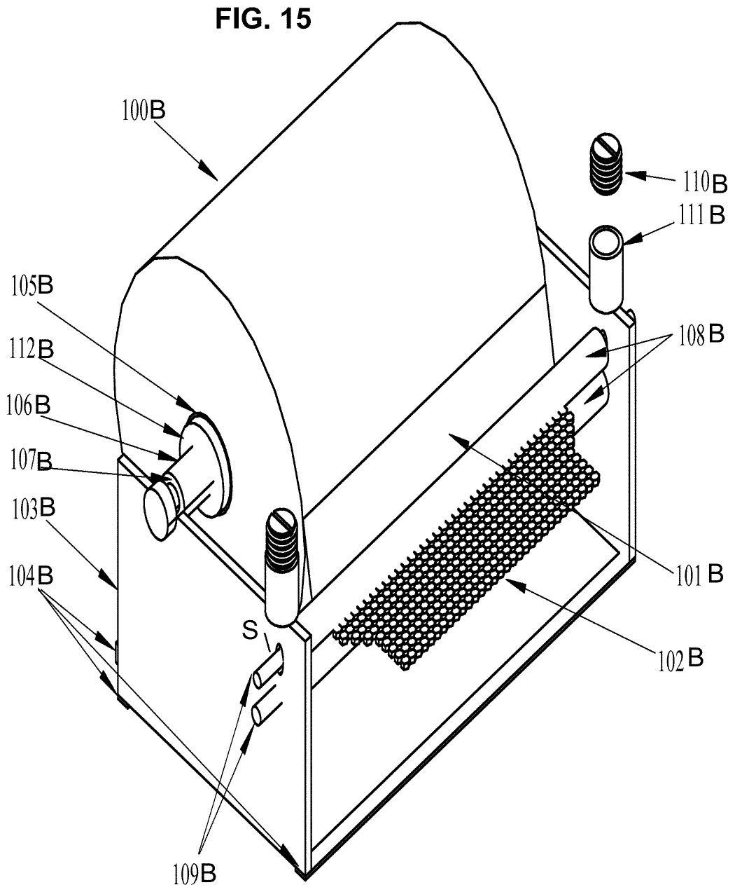

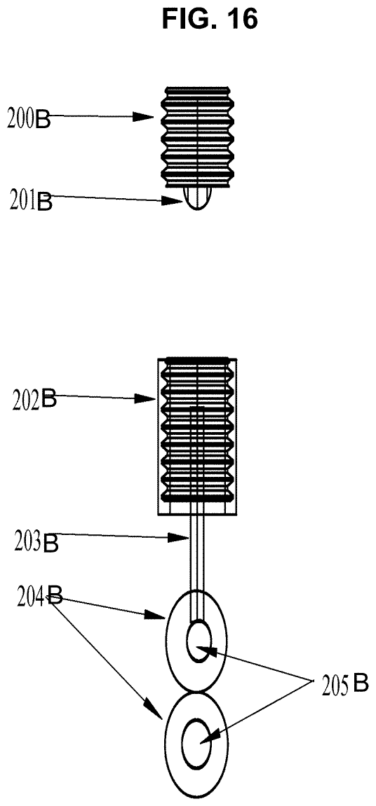

Additionally, another embodiment that is similar to that shown in FIG. 10 is shown in FIGS. 15-16.

With reference to FIGS. 15-16, the manual expander in this embodiment is made up of three major parts. The first being the frame to hold the roll of expanded slit sheet material and pressure roller fixture that feed and allows the stretching action of the material. The second part is the paper holding that enable the roll to turn freely as required. The third part is the pressure roller system that allows the paper to feed but simultaneously apply a back pressure to enable the stretching process of the expanded slit sheet material.

The framework is made up of two side frames and steel slats that are bolted in place to connect the two side frames together.

Handling the paper roll is quite simple wherein the paper is supported by a paper tube and two plastic centering cores that arrive with each expanded slit sheet paper roll. A steel rod is placed through the paper roll. On the left end of the rod is a permanent fixture that centers the paper so that the paper is centered on the machine. The second removable rod slides into place to hold the paper from sliding rightward. The rod itself is self-positioning by using a slot that is machined into both side frames which mates with a reduced diameter slot on the rod itself. These two create a locking mechanism that does not allow lateral movement of the rod.

The paper is then feed through the pressure rollers and awaits the use of an operator's hands to pull the paper through. A simple method of loading the paper is to guide the paper between the rollers with one hand and then with the other roll the upper pressure roller towards the back of the machine. This will force the paper through the rollers.

The pressure roller system is made up of a number of parts to enable a constant and even pressure regardless of the size of the paper roll. As it unwinds the paper roll gets lighter but, this will not affect the ability of the expander to maintain consistent stretching Properties. The first two parts are the horizontally oriented and parallel aluminum rolls that are held in place by a rod, or journal, that are at each end of the rubber-aluminum roll. Each rod is then affixed to the side frame through a brass or plastic bushing to inhibit side to side movement with the use of set screws. Each aluminum roller has a rubber to enhance the gripping action required to feed the paper. At this point, the rollers are able to turn freely.

To create the friction portion of the manual expander, spring-type vertically oriented set screw presses on both sides of the roller down on the bushing of the top roller system. By applying more or less pressure the set screws create the perfect pressure that allows the paper to feed and stretch but, not rip.

The set screw has a small protrusion at the bottom end that is spring loaded so that the pressure increases as you screw in the set screw. The ball bearing presses on a rod that in turn applies pressure to the bushing. The set screw itself is screwed into a machined cup that is attached to the frame. This cup is for the extra width of this type of spring operated set screw and the associated threads that enable the buildup of the pressure as the set screws are turned clockwise. Preferably, both set screws place the same amount of pressure on both sides of the roller or the paper can tend to lead to the side that has the greater pressure.

To set the pressure rollers to the right pressure, the user would guide the paper through the rollers and attempt to stretch the paper. If the paper does not stretch then a clockwise turn of both setscrews will add pressure. If the paper tears then the setscrews should be turned counterclockwise.

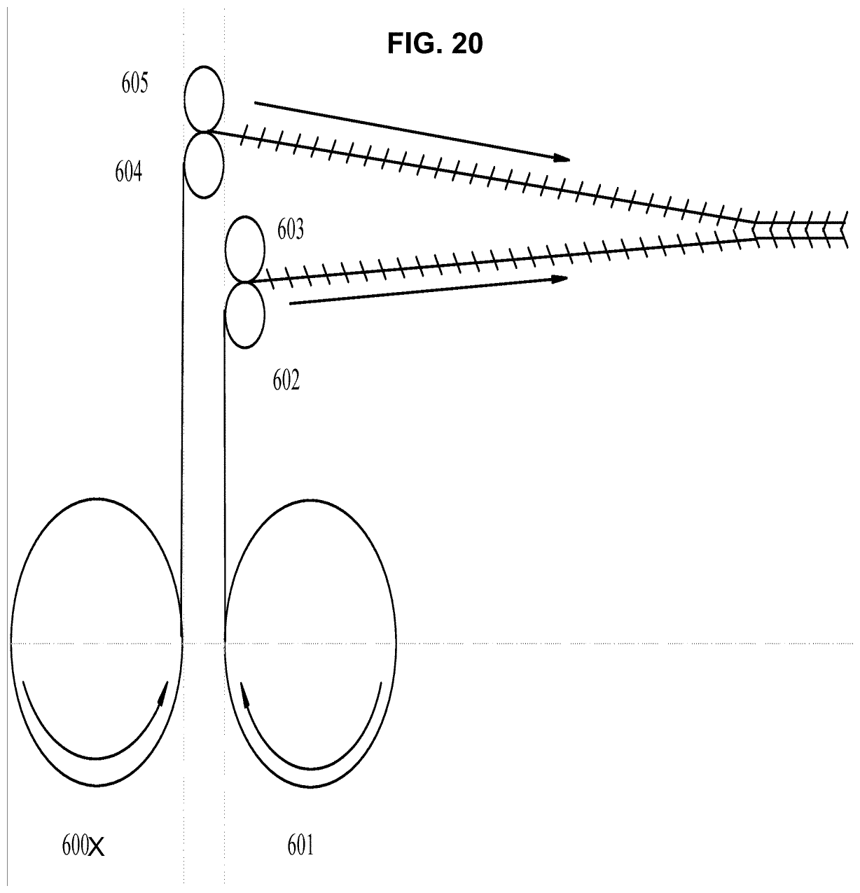

In the embodiment shown in FIGS. 15-16, a single roll of expandable slit sheet paper is employed, and, therefore, a single layer of expanded slit sheet material exits the expander. However, in some embodiments, plural layers can be conveyed together. For example, in some embodiments, plural layers of expandable slit sheet paper can be included within the expander. For example, FIG. 20 schematically shows a plurality of layers of expandable slit sheet paper being expanded concurrently. The embodiment shown in FIGS. 15-16 can be similarly adapted for plural layers being expanded together in some embodiments.

In some preferred embodiments, a mechanism is provided to inhibit nesting between adjacent layers. For example, in some embodiments, the expandable slit sheet paper can be configured to present a unique expansion pattern; for example, providing a non-uniform or chaotic pattern as described below. As another example, an interleaf (e.g., another layer of non-expandable paper) can be provided to inhibit nesting.

With respect to embodiments that employ a non-uniform pattern, by way of example, such a non-uniform layer can help the sheet material to package an item correctly. In some embodiments, a non-uniform layer of material is one that the hexagonal cells open in a random fashion at least 50% of the time to provide the inability for the cells to nest as they are wound against successive expanded layers around an object being packaged.

The present inventor has found that the deliberate desire for a chaotic pattern of switchbacks of at least 50% of the total number of cells create a non-nesting effect between the adjacent layers that buildup around an item to be wrapped by the expanded slit sheet material. These random changes are created by switchbacks due to the use of thinner paper that is less effected by the wedge effect of the tooling used to cut the paper as described in the prior art so referenced within this filing.

With respect to embodiments that employ an interleaf material, the prior art teaching of Ser. No. 14/480,319 desires a uniformity of cells with the deliberate use of a double layer feeding system that requires each layer to face in opposition to the layer underneath. In this case the deliberate use of uniformity inhibits nesting of the product as prior art teaches to cure this through the use of an interleaf that separates the cells as shown in filing U.S. Pat. No. 5,688,578.

In testing an illustrative example of this new structure against the uniformly but opposing double layer expanded slit sheet system a 400 foot roll of single layer cells created a diameter of 25″ while 200′ of the double layer system produced 22″. Each roll had the exact amount of paper in length and weight. Two layers of double equals 400 feet of continuously feed single layer chaotic product. The rolls at the end of the testing had the same square footage of material used. They varied in paper weight since the paper with the majority of virgin paper was thinner and therefore weight less per square foot as the recycled paper. The virgin paper as per the TAPPI standard weighed 50 pounds per 3000 square feet of material while the recycled paper weighed 60 pounds per 3000 square feet of material prior to expansion.

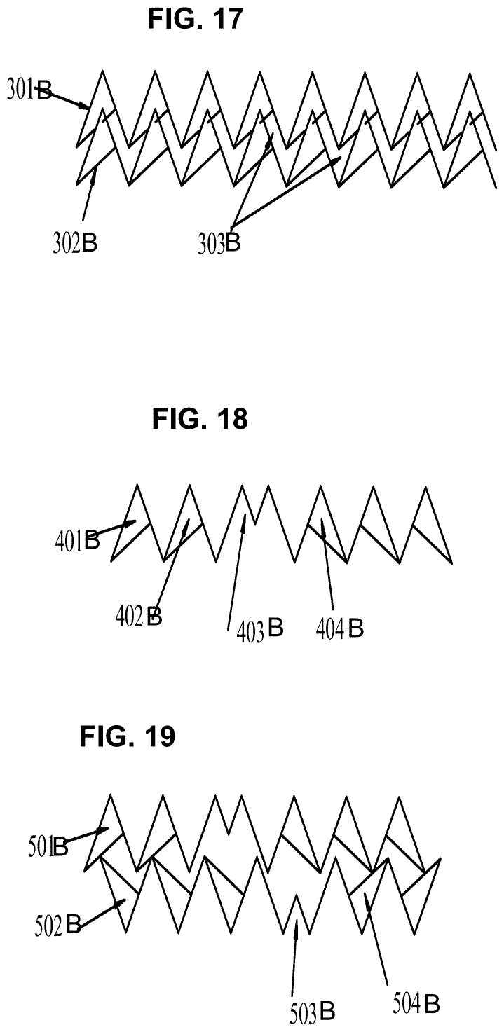

In some embodiments, the present invention provides a random chaotic pattern that produces the same non-nesting effect as the double layer in a similar way but, with a chaotic looking patter as shown schematically in, for example, FIGS. 17, 18 and 19.

In some embodiments, a double layer manual expander, as shown in FIG. 20, can be provided. In some embodiments, the expander would include two roll stands and two pressure roller systems as shown in FIG. 16. In some embodiments, the rolls of expandable slit sheet paper would be either thicker recycled paper and mounted in opposing cell patterns for uniform non-nesting layers or two virgin thinner paper layers that would open chaotically creating a non-nesting layers.

With reference to FIG. 15, FIG. 15 is a perspective view of the expander where 100B is the un-stretched slit sheet material sitting on paper core 105B. In the illustrative example, 105B is supported by plastic core 112B that in turn sits on steel rod 106B. 106B has a machined slot 107 that enables the rod to fit into a semi-circle slot with the exact radial dimensions on the side frame 103B. The paper 101B is guided from the paper roll 100B through pressure rolls 108B and become the expanded slit paper material 102B. In the illustrated example, the tensioning device of the rollers includes journals 109B, set screw cup 111B, and push rod 203B, shown in greater detail in FIG. 16. In the illustrated embodiment, side frame cross supports 104B hold the main side frame fixture 103B in position and secure the assembly.

FIG. 16 shows further details of the assembly of the pressure system that creates the tension for the rollers, wherein 205B are the journals to each roller not shown for simplicity. Bushings 204B trap the journals into position within the side frame also not shown for simplicity. Push rod 203B applies pressure to the top bushing 204B by the clockwise screwing action of set screw 200B with spring bearing 201B by a vertically coiled spring within the assembly of set screw 200B not shown. The set screw is placed into set screw cup 202B and turned clockwise to apply a downward force to push rod 203B which in turn applies the same force to bushing 204B and journals 205B. Since 205B is attached to the rollers 108B, the entire system receives pressure a braking force that inhibits the paper from exiting freely.

Additionally, in some embodiments, the upper journal 109B can be vertically movable within the slot S.

With respect to FIG. 17, FIG. 17 shows a simplified schematic side view of an expanded slit paper system that is nesting and is not optimally being used. 301B is the leg of the angled cell. One can tell the cell is facing right by line 302B that is a mere rendition to describe how the cell is facing. In reality, it is difficult to tell which way the cell is facing from a pure side view of the expanded slit sheet material. In this case, spaces 303B show not really the nesting that is occurring but the nesting that will occur just prior to nesting or the nesting process. Since the actual nesting that would occur in this instance would cause the upper and lower layers, as shown, to actually touch and therefore would look like only one layer from this viewpoint. As described in the background art this nesting is not an optimal use of the expanded slit sheet material.

FIG. 18 is a side view of expanded slit sheet material that has one switchback 403B as shown. The leg 401B is facing right as depicted by the rendition shadow leg of 402B. When switchback 403B occurs a halving of the cell is created at the midline of the cell leg and causes a distortion of the paper at the point of the switchback. The cells then face to the left as depicted by 404B.

FIG. 19 shows a net result of two layers that this chaotic effect has on the expanded slit sheet paper interaction according to some embodiments. Where right facing 501B interact with left facing cell 502B underneath, etc., as one observes the cells from left to right. The leftward facing cells interact with the lower and opposing rightward facing cells thereby inhibiting cell wall nesting. So, in this instance, a chaotic switchback cell structure creates the non-nesting effect of the uniformly opposed cell structure of the prior art. It should be understood that this concept is not as perfect as the uniformly opposing cell structure but, surprisingly the testing done proves otherwise.

FIG. 20 depicts a simplified side view of a double layer system that shows unexpanded slit sheet rolls 600X and 601 fed up to pressure rollers pairs 605-604 and 603-602 that would have the set screw system shown in FIG. 16. FIG. 20 shows, by way of example, a uniform opposing cell approach leading to a combining by hands pulling in the direction of the arrows.

In some alternative embodiments, while the above examples of the third embodiment apply resistance by pressure to the paper of the paper roll (i.e., along the face surface of the paper, rather than the thin edge surface of the paper) after removal from the paper roll as shown in FIG. 10 and in FIGS. 15-16, in alternative embodiments, the device can be configured to apply resistance by pressure to the face surface of the paper of the paper roll before removal from the paper roll. For example, in some embodiments, one or more rubberized rollers 1006 can be mounted proximate the paper roll, such as to move against the periphery of the paper roll such as to apply pressure to the paper roll such as to impart resistance. In some embodiments, the rubberized rollers can be moved via a similar mechanism to that shown in FIG. 10 or in FIGS. 15-16, or can be mounted via a cantilevered arm such as to reciprocate towards the paper roll. In this modification of the third embodiment, rather than pressurizing the paper between a paper of rubberized rolls that contact opposite side faces of the paper after exiting the roll, the at least one rubberized roll pressurizes the paper on the roll by pressing the outer periphery of the paper roll, such that the paper roll is pressurized between the supporting core and the at least one rubberized roll.

Although a rubberized roll is described, it should be appreciated that other embodiments could include other roll materials, such as, e.g., plastics, metals, and/or other suitable materials. For example, in some embodiments, the rollers (e.g., rollers 1006 in FIG. 10 or rollers 108A in FIGS. 15-16) can include friction members, such as, e.g., hooks and/or other friction members (see, e.g., illustrative examples discussed below).

In some embodiments, the embodiments of FIG. 10 and the embodiments of FIGS. 15-16 can be modified to employ an S curve manner of dispensing as taught in the present inventor's co-pending application Ser. No. 16/749,875, filed Jan. 22, 2020, the entire disclosure of which is incorporated herein by reference as though recited herein in full. For example, the expandable slit sheet paper can be dispensed via the pair of rollers of the embodiments of FIG. 10 and the pair of rollers of the embodiments of FIGS. 15-16 in an S curve format, such that the expandable slit sheet paper extends around a periphery of one of the rollers prior to passing between the pair of rollers to form an S curve configuration.

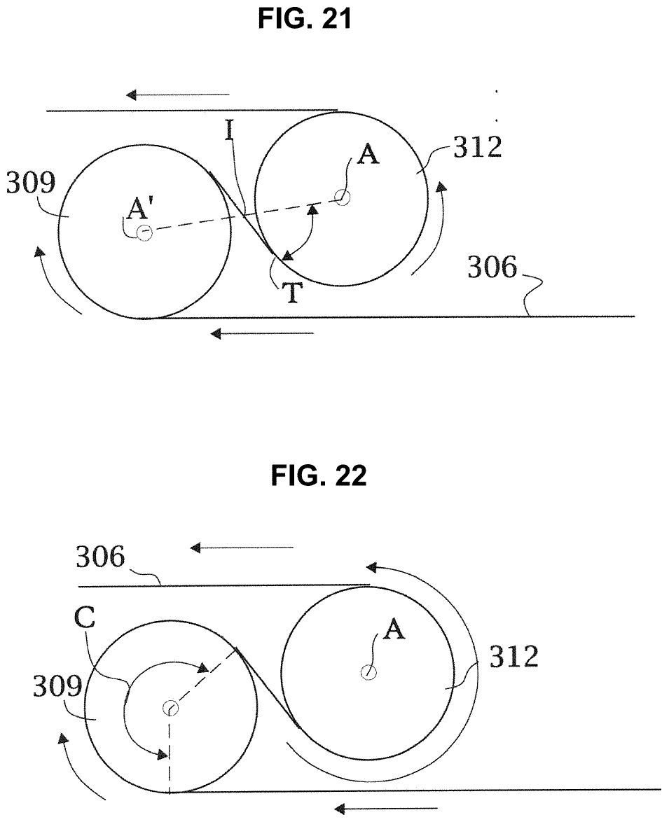

Towards this end, some embodiments of employing an S curve manner of dispensing are shown in, e.g., FIGS. 21-25. In FIGS. 21 and 22, the S shaped path that the slit paper takes between the rollers 309 and 312 can be described from a variety of perspectives. Here, it should be appreciated that in some embodiments, the rollers 309 and 312 can replace the rollers 1006 shown in FIG. 10 and rollers 108B shown in FIG. 15.

Looking from the perspective of angles formed by the axis of rollers 309 and 312, the intersection of the path of the slit paper with a line between the axis of each roller, and the tangent point at which the paper leaves a roller, is an acute angle. The relative positions of the two rollers and their proximity has a bearing on the acute angle that is formed. For example, the closer the proximity of the two rollers, the greater the acute angle.

Looking further to FIG. 21, the line between the axis A of roller 312 and the axis A′ of roller 309 intersects with the slit paper at point I. The angle (<) A-I-T, where T is the tangent point of contact between the paper and the circumference of the roller 312 is an acute angle. In the expansion system of FIG. 21, the slit paper tangentially contacts hook roller 309, interacts with the hook components of the hook roller 309, and is delivered tangentially to the point of tangent contact with hook roller 312. It should be noted that while contact with a roller is at a tangent point, the hooks of a hook roller can cause the slit paper to separate from the hooks at a point slightly beyond the point of tangency, depending upon the speed at which the paper is traveling and the tension on the slit paper. Accordingly, the term “tangent point” as employed herein, is inclusive of the slight deviation from a tangent.

With reference to FIG. 22, the slit paper 306 wraps around each of the rollers 309 and 312 following an S shaped path as indicated by the arrows shown in FIG. 21 and FIG. 22. The tendency of the expanded slit sheet to slip backward, which can cause the sheet to revert to becoming partly or fully unstretched and, thus, unexpanded, is in an inverse ratio to the degree of contact between the slit paper 306 and the hook surface of the rollers 309 and 312. Thus, where the contact region between the slit paper 306 and the hooks of the rollers is up to about ⅔ (around 235°) backward slip prevention is optimized. It is noted that a contact arc that is preferably less than 270 degrees is required for ease of machinery design and construction, and, accordingly, a lesser arcuate contact region is provided (e.g., lesser than 270 degrees).

The contact region advantageously is greater than ¼ of the circumference (i.e., 90°), and preferably greater than ½ of the circumference (i.e., 180°), and, most preferably, up to about 250°, which produces contact of the paper with about 70% of the hook surface of the rollers.

Furthermore, contact of the slit sheet with the hooks of each roller is preferably advantageously in the range from 90° to less than 270°. More preferably, contact of the slit sheet with the hooks of each roller is in the range from 180° to 235° which produces contact of the paper in the range from about 50% to 65% of the hook surface of the rollers. As shown in in the embodiment of FIG. 22, the arc C shows that the slit paper contacts more than 50% of the circumference of the hook roller 309. Notably, although the degree of contact of the paper with the hook surfaces of the rollers 309 and 312 can be different from one another, advantageously, the degree of contact can be optimized for each roller in the preferred embodiments.

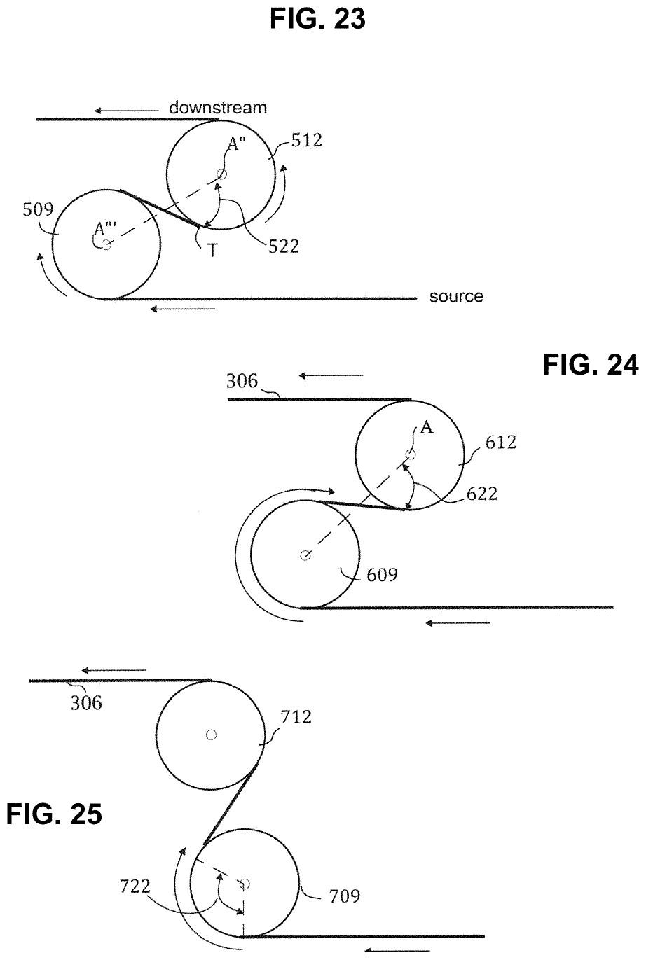

FIGS. 23, 24, and 25 show illustrative changes of degree of contact between the slit paper and the roller based upon the relative positions of the two hook rollers 509 and 512. As shown in FIG. 23, a line between axis A″ and axis A′″ intersects with the expanded paper flowing from roller 509 to roller 512 to form an acute angle 522.

In FIG. 24, the acute angle 622 is narrower than the acute angle 522 of FIG. 5. As shown in FIGS. 23 and 24, as the relative positions of rollers 509 and 512 are changed to the relative positions of rollers 609 and 612, the degree of arcuate contact between the slit paper 306 and the rollers decreases.

FIG. 25 shows an alternate “S” path flow pattern in which the slit paper 306 contacts the roller 709 along an arc 722 that is smaller than the arcuate contact regions illustrated in FIG. 23 and FIG. 24. As shown in FIGS. 24 and 25, as the relative positions of rollers 609 and 612 are changed to the relative positions of rollers 709 and 712, the degree of arcuate contact between the slit paper 306 and the rollers become further decreased.

As discussed above, although in some implementations of the embodiments shown in FIGS. 21-25 hook rollers are employed, in various embodiments, the rollers can include other materials, such as, e.g., a rubberized roll and/or other roll materials, such as, e.g., plastics, metals, and/or other suitable materials.

### Fourth Embodiment

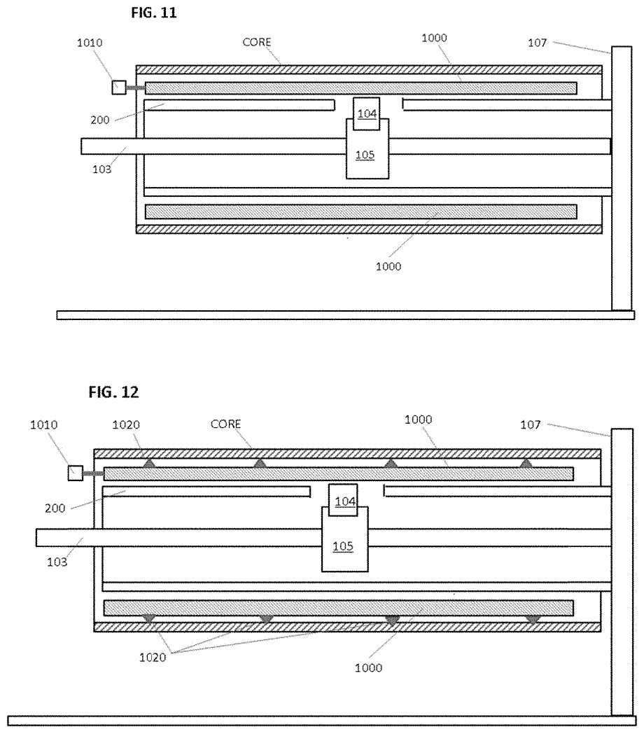

FIGS. 11-12 show a fourth embodiment which is similar to the embodiment shown in FIGS. 1-4, with the addition of an intermediary sleeve 1000 in between the sleeve 200 and the core (CORE), around which the paper roll is supported.

In the embodiment shown in FIGS. 11-12, rotation of the shaft 103 similarly cases rotation of a cam block 105, such as to raise/lower a shim 104. In some embodiments, these features can be similar to that shown in FIGS. 1-4. Moreover, other elements of the embodiment shown in FIGS. 1-4 can also be employed, such as, e.g., the use of a turning knob, etc. In the embodiment of FIGS. 11-12, rather than pressing against the interior of the core (CORE), the shim 104 is pressed against the intermediary sleeve 1000. In this manner, as with the embodiment shown in FIGS. 5-9, this embodiment shown in FIGS. 11-12 does not need to rely on features of the paper core for affecting the desired tensioning or resistance because tensioning or resistance is a result of sliding frictional engagement between an interior of the intermediate sleeve 1000 and the shim 4. As with the embodiment shown in FIGS. 5-9, the intermediate sleeve 1000 can be made with metal and/or other suitable materials (similar to material of insert 500 shown in FIG. 5).

In operation, as with the embodiment shown in FIGS. 5-9, the intermediate sleeve 1000 is preferably fixed with respect to core (CORE) such as to rotate with the rotation of the core. In some embodiments, the intermediate sleeve 1000 include projectable members 1020 that are configured to be retracted to a retracted state as shown in FIG. 11 and to be extended to a projected state as shown in FIG. 12. In the retracted state shown in FIG. 11 the intermediate sleeve 1000 is readily received within the core (CORE). On the other hand, once the core is inserted over the intermediate sleeve 1000, the projectable members 1020 can be extended to the projected state as shown in FIG. 12 such as to lock or fixedly be retained within respect to the interior of the core. In this manner, the intermediate sleeve 1000 will rotate along with the rotation of the core.

As shown in FIGS. 11-12, a projection mechanism 1010 is provided that is used to effect movement of the projectable members 1020. In various embodiments, the projection mechanism and the projectable members 1020 can be made of any known projection mechanisms and projectable members. For example, in some embodiments, the mechanism 1010 can include an air bladder that is used to pump air through a valve into expandable members 1020, along with a release valve that is opened to release air such as to retract the projectable members 1020. As another example, the extendable members can be pivotally mounted within an exterior groove on the intermediate sleeve 1000, and the mechanism 1010 can include an actuator shaft that pushes the extendable members, such that the extendable members pivot outwardly to engage the interior of the core. Then, to retract the members 1020, the actuator shaft can be moved in a reverse direction to retract the members 1020. In some illustrative embodiments, such an actuator shaft can include threads and the mechanism 1010 can involve a manually rotated knob that is rotated to cause the projectable members 1010 to move accordingly.

### Fifth Embodiment

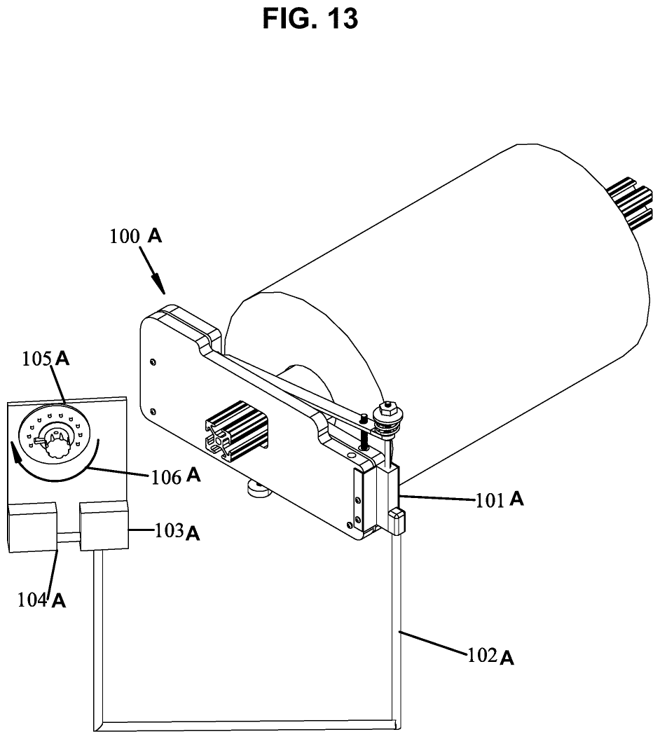

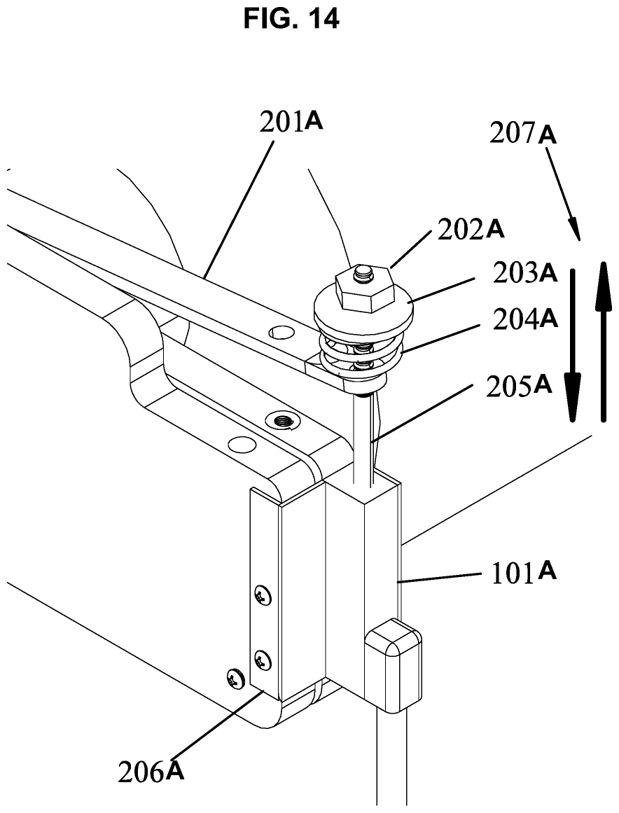

A fifth embodiment of the invention is shown in FIGS. 13-14. As shown in FIGS. 13-14, in some embodiments, the tensioning device can be adjusted or controlled via an automated mechanism rather than via a direct manual control.

Additionally, in some embodiments, a computer controller can also be provided that automatically adjusts the applied tensioning to a desired range or within a desired limit.

In various embodiments, automated aspects of this fifth embodiment can be implemented within any other embodiment of the invention shown herein. In some embodiments, with respect to embodiments like that shown in FIGS. 5-9 and 11-12, in which friction is applied between components other than the core, the frictional variation can be within a more limited range than when friction is applied against a paper core. Accordingly, automated control within such embodiments can achieve a smooth consistency for ease of use.

For the purposes of the present invention, the term “worm motor drive” as employed herein, refers to an electrical system by which a shaft will move upwards or downwards by electrical input.

For the purposes of the present invention, the term “control switch” refers to an electrical device than can adjust the worm gear motor to cycle up or down either by turning a knob or pressing an up or down button.

For the purposes of the present invention, the term “worm gear” refers to an electrical motor that can push a rod up and down. A motor of this type can be driven by air pressure and other designs that are found commonly within the art to move a shaft back and forth or up and down.

In the preferred implementations of this fifth embodiment, a time-saving solution for adjusting the position and, therefore, pressure exerted by a tensioning device is provided (such as, e.g., tension rod against a paper core around which the expanded slit sheet material is wound). According to some embodiments described herein, a tensioning device is adjusted by hand (for example, a thumbscrew is manually adjusted or turned by hand which in turn puts pressure on a spring). The spring in turn puts pressure on the tension rod and then finally onto the paper core.

This manual process is very easy and successful when the dispenser is on the packing table and within a short distance from the packer. According to this fifth embodiment, a power tension system is provided. For example, in some implementations, this new art can be employed to apply a powered tension system in the even that the unit is placed too far away for the packer (i.e., the individual operating the device) to easily operate the device by hand (e.g., to turn the thumbscrew by hand). In this case, the packer would have a controller that can control the tensioning via an automated system, such as, e.g., to either raise or lower a motor worm gear to add or subtract tension as needed.

The worm gear motor is the preferred device among a number of devices such as, a stepper motor, compressed air cylinder, jackscrew motor, etc., that could be used to apply pressure on the paper core (not numbered but shown in part in FIG. 13) by movement of tension rod 201A (FIG. 14) or other member to apply resistance against movement of the roll (e.g., by applying pressure against the paper core or otherwise apply resistance as described in various other embodiments set forth in this application).

FIG. 13 is a perspective view of an illustrative slit sheet paper dispensing system 100A that shows the position of a worm drive 101A as it sits on the front of the dispenser. It is electrically connected to the drive controller 103A via cabling 102A which, is connected by cabling to power supply 104A. In some illustrative examples, the control switch 105A is operated to cause the system to operate. For example, in some examples, the control switch 105A can be moved in clockwise direction 106A to cause the system to lift the tension rod upward and counter-clockwise to cause the system to lower the tension rod.

FIG. 14 is a perspective view and close-up view of the worm gear 101A as its fixed in position with bracket 206A. Worm gear shaft 205A is passed through a hole in tension rod 201A and through spring 204A and through washer 203A and is threaded on top to receive locking nut 202A. As the packer desires to increase or decrease tension by using control switch 105A in FIG. 13, not shown, the worm shaft 105A will move in an upward or downward direction as depicted with vertical arrows 207A.

While FIGS. 13-14 show an illustrative automated system for automated application of and adjustment of tensioning, it should be appreciated that the automated system shown in FIGS. 13-14 is merely an illustrative example and that various other embodiments can use other components for automated control of the tensioning.

Additionally, although FIGS. 13-14 show automated control of a tensioning employed in an embodiment in which tensioning is applied to a paper core or the like, other embodiments can employ automated control of tensioning in the context of any of the expander devices described in this present application.

Definitions Relating to Some Preferred Embodiments:

For the purposes of the present invention the term “paper roll” describes a slit sheet material wound around a core (such as, e.g., a paper core).

For the purposes of the present invention, the term “yoke” includes a structure contoured or shaped to support or carry a load.

For the purposes of the present invention, the term “rod” includes an elongated or straight element that is longer than it is wide and that is sufficiently rigid to support a roll of expandable slit paper. The term “rod” is inclusive of a slender bar, a pole, rod, shaft, strut, and a beam.

For the purposes of the present invention, the term “core support member” includes a structure that contacts an interior of a core member and bears the weight of a roll of paper that is wound around the core member by having the weight borne from the interior of a hollow core member.

For the purposes of the present invention, the term “paper core” includes a paper tube around which the expandable slit sheet paper is wound and “interior core member” includes that the core member has slit-expandable paper wound around the core member and is interior to the roll of paper.

For the purposes of the present invention, the term “curvature” includes an arcuate or essentially circular configuration that is shaped or curved like an arc or bow.

For the purposes of the present invention, the term “tensioning mechanism” includes a pressure assembly that applies pressure to variably increase or decrease friction and thereby variably resistance the unwinding the paper from the roll. The friction provides a rotational resistance that causes the slit paper to expand as it is drawn from the roll of slit sheet paper.

For the purposes of the present invention, the term “attached” means securely fixing one part to another as in the art of assembling wood, wood composites, metals, or plastics in order to create a bolted, screwed, secured, fastened, or sealed assembly and is inclusive of permanent assemblies and configurations that can be disassembled. Moreover, being “attached” does not require a direct connection between elements, but can include attachment via an intermediary member.

For the purposes of the present invention, the term “shim” includes, e.g., a thin, often tapered piece of material (such as wood, metal, or stone) used to fill in space between elements or components (such as, e.g., for support, leveling and/or adjustment of fit). In some examples, a shim can function as a wedge between two structures and can create a little extra height or a little extra space.

Broad Scope of the Invention:

Within this application, the use of individual numerical values is stated as approximations as though the values were preceded by the word “about”, “substantially”, or “approximately.” Similarly, the numerical values in the various ranges specified in this application, unless expressly indicated otherwise, are stated as approximations as though the minimum and maximum values within the stated ranges were both preceded by the word “about”, “substantially”, or “approximately.” In this manner, variations above and below the stated ranges can be used to achieve substantially the same results as values within the ranges. As used herein, the terms “about”, “substantially”, and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about”, “substantially”, or “approximately” will serve to broaden a particular numerical value or range. Thus, as a general matter, “about”, “substantially”, or “approximately” broaden the numerical value. Also, the disclosure of ranges is intended as a continuous range including every value between the minimum and maximum values plus the broadening of the range afforded by the use of the term “about”, “substantially”, or “approximately”. Thus, recitation of ranges of values herein are merely intended to serve as a shorthand method of referring individually to each separate value falling within the range, unless otherwise indicated herein, and each separate value is incorporated into the specification as if it were individually recited herein. To the extent that determining a given amount of variation of some the factors such as the criticality of the slit patterns, paper width differential pre- and post-expansion, paper weights and type, as well as other considerations known to those of skill in the art to which the disclosed subject matter is most closely related or the art relevant to the range or element at issue will have on the performance of the claimed subject matter, is not considered to be within the ability of one of ordinary skill in the art, or is not explicitly stated in the claims, then the terms “about”, “substantially”, and “approximately” should be understood to mean the numerical value, plus or minus 15%.

All U.S. and foreign patents, patent applications, patent publications, and all other publications cited in this application are incorporated herein by reference in this application in their entireties as though recited herein in full.

1. A device for dispensing expandable slit sheet paper, comprising:
a roll of expandable slit sheet paper,
an interior core member,
wherein said roll of expandable slit sheet paper is wound on said interior core member,
means for variably applying a frictional resistance to the rotation of said core member by varyingly applying pressure on an interior of said core member.

2. The device of claim 1, further including a reciprocating mechanism for reciprocating the rigid pressure member.

3. The device of claim 2, wherein said reciprocating mechanism includes a rotatable cam.

4. The device of claim 1, wherein said means for variably applying a frictional resistance includes a rigid pressure member that includes a reciprocated shim.

5. The device of claim 4, wherein said shim includes a curved outer surface that is movable towards and away from the inside surface of the core.

6. The device of claim 5, wherein said shim has a radius of curvature similar to that of the core.

7. The device of claim 4, wherein there is less than 3 shims.

8. The device of claim 4, wherein there is one shim such that pressure is applied in a single region by a surface of the one shim.

9-10. (canceled)

11. A device for dispensing expandable slit sheet paper, comprising:
a roll of expandable slit sheet paper,
an interior core member,
wherein said roll of expandable slit sheet paper is wound on said interior core member,
a core-attachment member configured to be fixed to the core for rotation with the core during use,
means for variably applying a frictional resistance to the rotation of said core member by varyingly applying pressure directly or indirectly to the core-attachment member.

12. The device according to claim 11, wherein said means for variably applying a frictional resistance to the rotation of said core member by varyingly applying pressure directly or indirectly to the core-attachment member applies pressure directly to the core-attachment member.

13. The device according to claim 11, wherein said core-attachment member is configured to be inserted at least partly within the interior of the core.

14. The device according to claim 11, wherein said core-attachment member is press-fit within the core.

15. The device according to claim 11, wherein said core-attachment member is secured to the core by one or more projectable member that extends outwardly to grip an interior of the core.

16. The device according to claim 11, wherein said means for variably applying a frictional resistance to the rotation of said core member by varyingly applying directly or indirectly to the core-attachment member includes variably applying pressure with a rigid pressure member.

17. The device of claim 16, further including a reciprocating mechanism for reciprocating the rigid pressure member.

18. The device of claim 17, wherein said reciprocating mechanism includes a rotatable cam.

19. The device of claim 16, wherein said rigid pressure member includes a reciprocated shim.

20. The device of claim 19, wherein said shim includes a curved outer surface that is movable towards and away from the inside surface of the core.

21. The device of claim 20, wherein said shim has a radius of curvature similar to that of the core.

22. The device of claim 19, wherein there is less than 3 shims.

23. The device of claim 22, wherein there is one shim such that pressure is applied in a single region by a surface of the one shim.

24-59. (canceled)
